(19) United States
(12) Patent Application Publication
(10) Pub. No.: US 2007/0018881 A1
(43) Pub. Date: Jan. 25, 2007

(54) Mode S zone marker

(75) Inventor: Larry D. King, Sammamish, WA (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 11/166,857

(22) Filed: Jun. 24, 2005

(51) Int. Cl. G01S 13/76

(52) U.S. Cl. 342/46; 342/30; 342/32; 342/37

(57) ABSTRACT

An apparatus and method for a zone marker having an L-band radio antenna that is structured for receiving a Mode S radio frequency interrogation signal and broadcasting a Mode S radio frequency reply signal; a Mode S transponder that is structured for generating a Mode S radio frequency reply signal and is coupled to inject the reply signal into the antenna; and a dedicated processor that is coupled for receiving the Mode S radio frequency interrogation signal from the antenna and is structured for operating one or more algorithms for automatically generating a Mode S radio frequency reply signal in response thereto, the processor is further coupled for causing the transponder to inject the reply signal into the antenna. The zone marker includes an internal battery coupled for powering both the processor and transponder.

### FIELD OF THE INVENTION

The present invention relates to ground-based zone marker devices and methods, and in particular to ground-based radio frequency zone marker using Station Keeping Equipment (SKE) for determining range and bearing data to the zone marker.

### BACKGROUND OF THE INVENTION

Station Keeping Equipment (SKE) allows as few as two similarly equipped aircraft and as many as one hundred or more aircraft to maintain relative position and separation. SKE systems provide relative position information on all aircraft in a formation, and include distance, bearing, heading, airspeed, and relative altitude information which allows aircraft in a formation to perform precision airdrops, rendezvous, air refueling, and air-land missions at night and in all weather conditions, including instrument meteorological conditions (IMC). SKE systems in military aircraft, for example the C-130, communicate positional, range and control information between formation members. SKE transmitter/receivers typically operate on frequencies between 3.1 to 3.6 GHz and with data transfer rates of 40 Kbps.

SKE systems are generally compatible with ground-based zone markers (ZM). Ground-based zone markers are radio beacons that operate in the same frequency range as the SKE equipment. The SKE equipment interrogates the zone marker, which replies with live RF pulse data. The SKE equipment then computes bearing to the zone marker as a function of signal phase difference at the antenna, and computes range as a function of signal return times. Ground-based zone markers thus provide navigational aids for aircraft equipped with SKE equipment. Using the ground-based zone marker, SKE equipped aircraft are able to conduct air drops in IMC without use of other external aids such as Global Positioning System (GPS) equipment or ground-mapping radar.

However, the range and bearing data computed by state of the art SKE equipment is inherently limited in precision. Therefore, devices and methods for overcoming these and other limitations of typical state of the art zone markers and interrogation equipment are desirable.

### SUMMARY OF THE INVENTION

The present invention is an apparatus and method for a Mode Select (Mode S) based zone marker (ZM) for military air drops at least because TCAS-based technology may replace traditional high frequency Station Keeping Equipment (SKE) for formation and station keeping.

Current military ACAS Mode S based technology is not compatible with current military zone marker technology. The present invention is a military zone marker structured to facilitate use of Mode S radio frequency (RF) technology that operates nominal interrogation and reply frequencies of 1030/1090 MHz.

The military zone marker of the present invention is structured to provide the same zone marker capability available today, but operating at the nominal 1030/1090 MHz frequencies of Mode S. The military zone marker of the present invention receives interrogation signals from and transmits reply signals to military ACAS (MILACAS) equipped aircraft using standard 1030/1090 MHz Mode S technology. According to one aspect of the invention, the military zone marker reply signals to MILACAS interrogation signals include latitude, longitude, and altitude data which allow military ACAS (MILACAS) equipped aircraft to “track” to zone marker to a selected drop point. The military zone marker of the present invention supports the Army's Strategic Brigade Airdrop capability. The military zone marker of the present invention operates in off, standby, normal, reprogramming and built-in-test (BIT) modes. In standby mode, the zone marker inhibits all transmissions in response to valid 1030 MHz interrogations. In normal mode, the zone marker transmits and respond to all valid interrogations. In BIT mode, the zone marker performs internal self-tests, and in the reprogramming mode, the zone marker is rendered capable of accepting a new operational program.

Accordingly, the present invention provides a zone marker having an L-band radio antenna that is structured for receiving a Mode S radio frequency interrogation signal and broadcasting a Mode S radio frequency reply signal; a Mode S transponder that is structured for generating a Mode S radio frequency reply signal and is coupled to inject the reply signal into the antenna; and a dedicated processor that is coupled for receiving the Mode S radio frequency interrogation signal from the antenna and is structured for operating one or more algorithms for automatically generating a Mode S radio frequency reply signal in response thereto, the processor is further coupled for causing the transponder to inject the reply signal into the antenna. The zone marker includes an internal battery coupled for powering both the processor and transponder.

According to one aspect of the invention, the processor is further operable in a plurality of different operational modes, including one or more of a standby mode, a normal operation mode, a built-in-test mode, a reprogramming mode, and a deactivated mode.

According to one aspect of the invention, the zone marker of the invention includes an operator interface that is coupled to the processor for selecting among the different operational modes.

According to one aspect of the invention, the normal operation mode causes the processor to receive the interrogation signal, determine validity of the received interrogation signal, and responsively generate the reply signal in response thereto to a valid interrogation signal.

According to one aspect of the invention, packaging encompassing the antenna, processor and transponder is structured for permitting the zone marker of the invention to be air dropped using a LC-1 pack where after the antenna, processor and transponder are made operational.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block diagram that illustrates a military Airborne Collision Avoidance System (ACAS) Instrument Formation Flying System (IFFS) device according to one embodiment of the invention;

FIG. 2 is a block diagram that illustrates a military ACAS zone marker (ZM) device according to one embodiment of the present invention; and

FIG. 3 is a perspective view of the ZM beacon device according to one embodiment of the present invention.

### DETAILED DESCRIPTION OF PREFERRED EMBODIMENT

In the Figures, like numerals indicate like elements.

Many varieties of collision avoidance systems (CAS) and conflict detection systems for aircraft are known. These systems fall into the general categories of passive and active systems. Active collision avoidance systems generally utilize transmission broadcasts from the aircraft to determine relevant information relating to other aircraft in the area, and/or provide its own relative information to other aircraft in an area. The most prevalent active system used in the U.S. today, is the Traffic Alert and Collision Avoidance System (TCAS) which is internationally known as Airborne Collision Avoidance System (ACAS).

TCAS offers pilots of private, commercial and military aircraft reliable information to track local traffic and avoid potential collisions with other aircraft. TCAS is a family of airborne devices that operate independently of ground-based Air Traffic Control (ATC) systems. Since inception, three different TCAS control levels have evolved: TCAS I is intended for commuter and general aviation aircraft and provides a proximity warning only that assists the pilot in visually acquiring intruder aircraft; TCAS II is for commercial airliners and business aircraft to provide pilots with traffic and resolution advisories in the vertical plane; and TCAS III, which is still awaiting approval by the Federal Aviation Administration (FAA), will purportedly provide resolution advisories in the horizontal as well as vertical plane.

TCAS detects the presence of nearby aircraft equipped with transponders that reply to ATCRBS Mode-C or Mode S interrogations. When nearby aircraft are detected, a processor portion of the TCAS operates algorithms that track and continuously evaluate the potential of these aircraft to collide with its own aircraft.

For surveillance, TCAS interrogations are transmitted over a nominal 1030 MHz interrogation channel from the TCAS equipped aircraft to any aircraft within range of the transmission. The interrogation requests a reply from transponder-equipped aircraft within range of the transmission to reply with their pertinent position and/or intent information. Transponder-equipped aircraft within range of the transmitted interrogation reply by transmitting their associated information over a nominal 1090 MHz reply channel. This information can include altitude, position, bearing, airspeed, aircraft identification and other information of the replying aircraft to assist the TCAS in tracking and evaluating the possibility of collision with the replying aircraft.

TCAS operates stored algorithms for tracking nearby “intruder” aircraft and displays a symbol depicting the intruder on traffic displays located in the cockpit. The displayed symbols allow a pilot to maintain awareness of the number, type and position of aircraft within the vicinity of his own aircraft.

For collision avoidance, TCAS predicts time to an intruder's closet point of approach (CPA) and a separation distance at the CPA, by operating algorithms that calculate range, closure rate, vertical speed and altitude. TCAS tracks intruder aircraft within a local range, evaluates collision potential, displays and/or announces traffic advisories (TAs). Some TCAS, e.g., TCAS II, recommend evasive actions in the vertical plane, known as a Resolution Advisories (RAs), to avoid potential collisions.

Intruder aircraft not equipped with operating transponders cannot reply to interrogations and are not detected by TCAS. Military aircraft equipped with identification friend or foe (IFF) systems operating in Mode 4 do not reply to interrogations and are not be detected by TCAS. Other aircraft may not receive the TCAS interrogations for different reasons, e.g., interference, lowering landing gear when intruder was being tracked by only the bottom antenna, or interference limiting, and are not detected by TCAS.

Military aircraft frequently fly in multi-aircraft groups known as formations. A problem occurs when all planes in a given formation are actively interrogating with their TCAS. Notably, the TCAS equipped aircraft both in and outside the formation may detect a seemingly high density of planes in a traffic area due to the formation and thus use a type of unnecessary range adjustment known as “interference limiting” to reduce the transmission power of their respective broadcasts and reduce their receiver sensitivity to compensate for the perceived density. This interference limiting degrades collision avoidance safety to unacceptable levels by, for example, significantly decreasing interrogation range in areas where aircraft are flying at high speeds. Even small formations of two or three TCAS-enabled aircraft may result in interference limiting to both non-formation and formation aircraft.

Presently, under the requirements of the FAA and various other airworthiness authorities in several countries, only one or few aircraft in a formation is allowed to have an actively interrogating TCAS. If all the aircraft in a formation are not interrogating, significant safety problems may arise. The non-interrogating formation aircraft are not be aware of potential collision threats with local non-formation aircraft because their respective TCAS is not operating. The non-interrogating aircraft of the formation also have no warning by their respective TCAS of potential collisions with other formation aircraft.

Honeywell International, Inc. has developed an Enhanced TCAS (ETCAS) collision avoidance system that is structured to specifically address military formation-flying insufficiencies of conventional TCAS. ETCAS permits military aircraft to fly in formation by offering a rendezvous-type feature in collision avoidance systems that allow aircraft to fly in formation with other aircraft without generating RAs and TAs against one another.

TCAS or ETCAS collision avoidance technology may be used for formation and station keeping in place of the traditional high frequency Station Keeping Equipment (SKE). Therefore, it would be useful for military air drops to have a zone marker that is compatible with interrogation equipment of the type operated by TCAS or ETCAS collision avoidance systems.

The Figures illustrate the apparatus and method of the present invention for a zone marker and acquisition system having a substantially self-contained zone marker structured for generating a radio transmission reply signal in a TCAS reply frequency range in response to receiving a radio interrogation signal in a TCAS interrogation frequency range, and a military ACAS IFFS that is structured for generating a radio transmission interrogation signal in a TCAS interrogation frequency range, the interrogation signal being structured for eliciting the radio transmission reply signal from the zone marker.

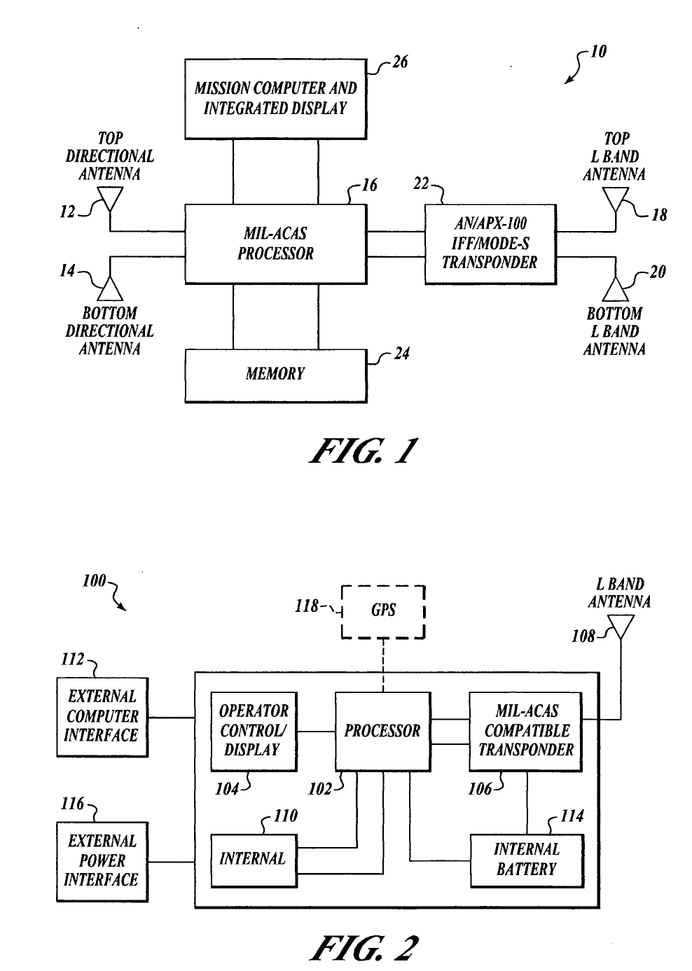

FIG. 1 is a block diagram that illustrates a military Airborne Collision Avoidance System (ACAS) Instrument Formation Flying System (IFFS) 10 of the invention that modifies an existing ETCAS and IFFS to provide a low probability of detection, all weather, intra-formation positioning and collision avoidance capability. ETCAS is an Enhanced TCAS that provides means for military aircraft to fly in formation by offering a rendezvous-type feature in collision avoidance systems that allows aircraft to be able to fly in a formation with other aircraft without generating either Resolution Advisories (RA) or Traffic Advisories (TA) against one another. The military ACAS IFFS utilizes a reserved military message pair in the ground-based commercial Air Traffic Control (ATC) system and commercial aircraft TCAS II system Mode Select (Mode S) 1030 MHz interrogation and 1090 MHz reply nominal frequency bands to establish an inter-formation data link that provides collision avoidance and formation positioning for equipped aircraft. The military ACAS IFFS of the invention uses unique identification that results in a low probability of interception.

The military ACAS IFFS 10 includes top and bottom directional antennas 12, 14 coupled to a processor 16. Top and bottom L-band antennas 18, 20 are coupled to the processor 16 through a combination IFFS and Mode S transponder 22. The processor 16 is coupled to access one or more computer operable algorithms stored in a non-volatile memory 24. The military ACAS IFFS 10 includes bus and backplane interconnections to couple the processor 16 for communicating with a mission computer and integrated display device 26. The processor 16 and memory 24 are structured to be capable of being upgraded with newer technology without requiring application software changes.

The military ACAS IFFS 10 of the present invention is structured to replace an existing onboard IFFS and is incompatible with existing prior art RF zone marker beacons that operate in the high frequency ranges of prior art SKE equipment. The military ACAS IFFS 10 of the present invention thus changes the operation of RF zone marker beacons from interfacing with the traditional high frequency SKE to TCAS based technology for military air drops, which supports a future change from the traditional high frequency SKE to TCAS based technology for military formation and station keeping.

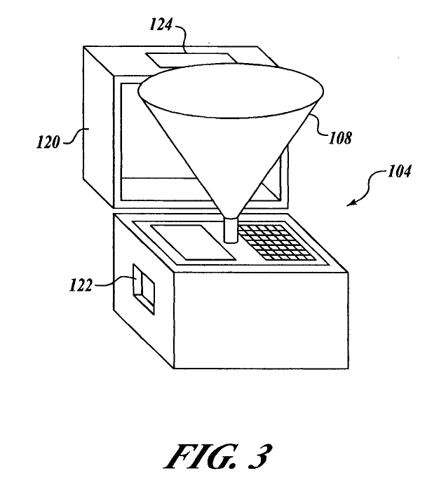

FIG. 2 is a block diagram that illustrates a military ACAS zone marker (ZM) 100 of the present invention. The ZM beacon 100 of the present invention includes a dedicated internal ZM processing component 102 that is accessed through an operator control panel 104 coupled thereto. The ZM processing component 102 is coupled to a Mode S transponder 106 that is compatible with the airborne military ACAS IFFS 10 device of the invention. The Mode S transponder 106 is coupled to one or more omnidirectional L-band antennas 108. The transponder 106 includes transmit and receive modes that are optionally structured to be mutually exclusive to avoid damage to the equipment. Whenever the Mode S transponder 106 is not broadcasting, it is monitoring, or “listening,” for transmissions simultaneously on its one or more omnidirectional antennas 108.

The operator control panel 104 includes a display and controls that are both structured to be unambiguous and conform to MIL-STD-1472. Computer programs stored in the non-volatile memory 110 and operable by the internal ZM processing component 102, as well as the operator control panel 104 and other equipment interfaces, are structured to provide a functional interface between the ZM beacon 100 and its users, both operators service personnel maintaining the system. The operator control panel 104 and other equipment interfaces are structured to optimize compatibility with personnel, while minimizing conditions which would degrade human performance or contribute to human error.

Operational programs for controlling the internal ZM processing component 102 are stored in non-volatile memory 110 which may be included within the ZM beacon 100. The internal ZM processing component 102 and non-volatile memory 110 are structured for being upgraded with newer technology without requiring application software changes. For example, an external computer interface 112 is structured to support reprogramming of the internal ZM processing component 102 and re-loading the non-volatile memory 110 with updated computer programs. The external computer interface 112 is structured for loading operational software using a commercially available data transfer medium. Alternatively or in addition, the external computer interface 112 is structured as a single reprogramming point for loading the operational software via an Air Force standard programmer loader verifier (PLV). The external computer interface 112 optionally provides growth to digital data link communication capability.

An internal battery 114 is coupled to power the ZM processing component 102 and transponder 106. Fully charged, the battery 114 provides the ZM beacon 100 with twenty hours or more of continuous operation. An external power interface 116 is structured to couple the ZM beacon 100 to an external power source, such as a 24V-30V external DC power source. The external power interface 116 receives external power input for both recharging the battery 114 and substantially continuous operation of the ZM beacon 100.

The ZM beacon 100 is air lifted, trucked or otherwise positioned at a selected drop point where it supports airdrops, for example the ZM beacon 100 supports the precision airdrop capability of military C-130 aircraft. The ZM beacon 100 is packaged to be capable of being air dropped using a LC-1 pack or an equivalent, and then becoming operational. According to one embodiment of the invention, the ZM beacon 100 is automatically activated, after setup and power-on, by a Mode S interrogation signal received from a master aircraft equipped with the military ACAS IFFS 10 device of the invention, whereupon the ZM beacon 100 has an operating range of about twenty nautical miles or more.

Operational Modes

The ZM beacon processor 102 functions in operational modes selectable via the operator control panel 104. The operational modes include standby, normal operation, built-in-test (BIT), reprogramming and an “off” mode, whereby the ZM beacon 100 is able to be completely deactivated. In the standby mode, the ZM beacon processor 102 inhibits all transmissions in response to valid interrogations. In the normal mode, when the ZM beacon 100 is within range to receive Mode S interrogation transmissions from the military ACAS IFFS 10 that solicit replies from transponders of a nearby ZM beacon 100, the ZM beacon processor 102 of the nearby ZM beacon 100 receives the Mode S interrogation radio signals transmitted at the nominal 1030 MHz Mode S interrogation frequency, determines validity of the received interrogation signal, and responsively generates replies to all valid interrogations. A valid interrogation signal is a signal received from an aircraft equipped with the military ACAS IFFS 10, and validity of the received interrogation signal is determined by a determination that the interrogation signal originated from an aircraft equipped with the military ACAS IFFS 10. The processor 102 then outputs a signal that causes the transponder 106 to inject the reply signal into the antenna 108, whereupon the antenna 108 transmits reply signal at the nominal Mode S reply frequency of 1090 MHz.

In the BIT mode, the ZM beacon processor 102 performs internal self-tests and provides a clear indication of internal health status to the operator. In the reprogramming mode, the ZM beacon processor 102 is capable of accepting and storing in the non-volatile memory 110 a new operational program for controlling the internal ZM processing component 102.

The ZM control panel 104 display and controls support selection of all operational modes. The ZM control panel 104 also supports manual entry of positional data, including latitude, longitude, and altitude. However, these positional data may be pre-programmed into the ZM beacon 100. The ZM control panel 104 control and display indications are structured to clearly indicate a selected mode of operation of the ZM beacon 100. The control panel 104 indicates currently programmed latitude, longitude, and altitude data. The control panel 104 also indicates receipt of Mode S interrogations, as well as replies to the received Mode S interrogations. The ZM control panel 104 displays and controls are readily accessible and operable by personnel wearing chemical/biological protective equipment and/or arctic cold weather equipment. Furthermore, all ZM beacon 100 equipment lighting is compatible with the use of night vision goggles (NVGs). Light producing portions of the ZM beacon 100 equipment, e.g. the ZM control panel 104 displays and controls, are structured to satisfy requirements of ASFC/ENFC 96-01 Type 1 Class B.

The ZM beacon 100 receives active interrogations from and responds to aircraft equipped with the military ACAS IFFS 10 device of the invention only. According to one embodiment of the invention, the ZM beacon 100 replies only to interrogations transmitted at the nominal 1030 MHz Mode S interrogation frequency, and the interrogation replies are live RF pulse data transmitted at the nominal Mode S reply frequency of 1090 MHz. The Mode S transponder reply or “squitter” contains Mode S type unique address code identification and altitude information.

The onboard military ACAS IFFS 10 equipment receives the reply, then computes relative bearing to the ZM beacon 100 as a function of signal phase difference at the antenna, and computes relative range as a function of the round-trip time between the transmission of the interrogation and the receipt of the reply signal using TCAS-type algorithms stored in the non-volatile memory 24. The algorithms may also permit the ACAS IFFS 10 equipment compute relative altitude of the ZM beacon 100. Using the ZM beacon 100 information, the ACAS IFFS 10 equipment may also determine a time to closure based on its own flight information. The onboard military ACAS IFFS 10 equipment then allows aircraft to “track” the cooperating ZM beacon 100 to the selected drop point.

According to another embodiment of the invention, interrogation replies by the ZM beacon 100 include latitude, longitude, and altitude data. For example, the ZM beacon 100 is optionally structured to receive latitude, longitude, and altitude data from either internal or external satellite-based Global Positioning System (GPS) equipment 118. Thereafter, the ZM beacon 100 is treated as a way point that is located on the ground.

According to another embodiment of the invention, interrogation replies by the ZM beacon 100 provide information using an Automatic Dependent Surveillance-Broadcast (ADS-B) type system. ADS-B is an automatic and periodic transmission of flight information from an aircraft that is similar to that of the current Mode S transponder squitter, but conveys more information. ADS-B systems typically rely on the satellite-based GPS equipment to determine a precise location in space. An aircraft equipped with ADS-B broadcasts its positional information and other data, including velocity, altitude, and whether the aircraft is climbing, descending or turning, type of aircraft and its unique alphanumeric identifier Flight ID, as a digital code over a discrete frequency without being interrogated. Other aircraft and ground stations within roughly twenty nautical miles or more receive the broadcasts and display the information on a screen, for example a Cockpit Display of Traffic Information (CDTI).

According to this embodiment of the invention, the ZM beacon 100 generates an automatic and periodic broadcast of ADS-B type information as a digital code over a discrete frequency without being interrogated. The ADS-B type information in the broadcast including but not limited to a precise location in space including altitude. The broadcast optionally includes one or more of a unique alphanumeric identifier similar to the Flight ID in ADS-B broadcasts by aircraft. ACAS IFFS 10 equipped military aircraft within a selected range, such as one hundred and fifty miles, receive the broadcasts and display the information on a screen such as the CDTI.

The ZM beacon 100 is structured to comply with national and international spectrum standards and guidance on the use of the electromagnetic spectrum. Furthermore, the ZM beacon 100 equipment is structured to be certifiable in accordance with API 33-118 and AFM 33-120 to be supportable in the electromagnetic spectrum prior to fielding the first aircraft.

FIG. 3 is a perspective view of the physical ZM beacon 100 according to one embodiment of the present invention, including the one or more L-band antennas 108, are collapsible into a container 120 that does not exceed 720 cubic inches in height, width and depth, with a maximum weight of 35 pounds. The physical ZM beacon 100 is equipped with handling provisions 122, such as a pair of handles or grasp areas that aid in handling and transportation, are provided on the container 120 that are appropriate for the size, weight, and usage of the ZM beacon 100. The ZM beacon 100 is finish coated in accordance with MIL-HDBK-1568 for finish systems or equivalent commercial standards.

The physical ZM beacon 100 is structured to withstand and continue to perform reliably after a vibration profile for fixed wing aircraft, propeller engines, such as the vibration profile specified in MIL-STD-81 OE, Section 514.4, Category 4, and to withstand shocks of the type associated with dropped equipment, such as the shock specified in MIL-STD-81 OE, Section 514.4, Procedure 4 with the drop test being modified to 6.85 feet.

The ZM beacon 100 is further structured to perform reliably in ambient temperature conditions of −40 degrees to +59 degrees C., and to survive without degradation of performance in ambient temperature conditions of −51 degrees to +71 degrees C.

The ZM beacon 100 is further structured to survive without any degradation of performance ambient pressure from sea level to 35,000 feet and pressure changes from 8000 feet or 10.92 psia to 35,000 feet or 3.46 psia at a minimum rate of 1800 feet per second or 0.5 psi per second, which is associated with rapid decompression at altitude.

The ZM beacon 100 is further structured to withstand degradation under solar radiation conditions of the type specified in MIL-STD-8 TOE, Section 505.3, while it is further structured to be capable of operation without degradation under rain conditions of the type specified in MIL7STD-810E, Section 506.3, with rain fall at 4 inches per hour and wind at 40 MPH. Furthermore, the ZM beacon 100 equipment is structured for operation without degradation under humidity conditions of the type specified in MIL-STD-810E, Section 507.3.

To the extent possible, the ZM beacon 100 is structured using fungus-inert materials to withstand exposure to fungus growth in both operating and non-operating conditions. Additionally, the ZM beacon 100 is structured for operation without degradation under the salt fog conditions of the type specified in MIL-STD-810E, Section 509.3, and during exposure to both sand and dust.

A nameplate 124 permanently attached to the physical ZM beacon 100 provides identification of the device without adversely affecting either appearance or performance.

While the preferred embodiment of the invention has been illustrated and described, it will be appreciated that various changes can be made therein without departing from the spirit and scope of the invention.

What is claimed is:

1: A zone marker and acquisition system, comprising:
a substantially self-contained zone marker device that is structured for transmitting a Mode S radio frequency reply signal in response to receiving a Mode S radio frequency interrogation signal; and
an interrogation device that is structured for transmitting the Mode S radio frequency interrogation signal.

2: The system of claim 1 wherein the zone marker device further comprises a processor structured for receiving the Mode S interrogation signal, and generating the Mode S reply signal in response thereto.

3: The system of claim 2 wherein the zone marker device further comprises an L-band antenna that is structured for receiving the Mode S radio frequency interrogation signal and for transmitting the Mode S radio frequency reply signal, and a Mode S transponder coupling the L-band antenna to the processor.

4: The system of claim 3 wherein the Mode S radio frequency reply signal further comprises identification and altitude information.

5: The system of claim 4 wherein the interrogation device further comprises a processor that is coupled to receive the Mode S radio frequency reply signal and is further structured to operate one or more algorithms for computing a bearing and range to the zone marker device.

6: The system of claim 3 wherein the Mode S radio frequency reply signal further comprises positional data including one or more of latitude, longitude, and altitude data.

7: The system of claim 6 wherein the zone marker processor is further structured for being programmed with the positional data.

8: The system of claim 6 wherein the zone marker processor is further structured for receiving the positional data from a Global Positioning System device.

9: A zone marker, comprising:
an L-band radio antenna structured for receiving a Mode S radio frequency interrogation signal and broadcasting a Mode S radio frequency reply signal;
a Mode S transponder structured for generating a Mode S radio frequency reply signal and coupled to inject the reply signal into the antenna; and
a dedicated processor coupled for receiving the Mode S radio frequency interrogation signal from the antenna and structured for operating one or more algorithms for automatically generating a Mode S radio frequency reply signal in response thereto, the processor being further coupled for causing the transponder to inject the reply signal into the antenna.

10: The zone marker of claim 9, further comprising an internal battery coupled for powering the processor and transponder.

11: The zone marker of claim 9 wherein the processor is further operable in a plurality of different operational modes, including one or more of a standby mode, a normal operation mode, a built-in-test mode, a reprogramming mode, and a deactivated mode.

12: The zone marker of claim 11, further comprising an operator interface coupled to the processor for selecting among the different operational modes.

13: The zone marker of claim 12 wherein the normal operation mode causes the processor to receive the interrogation signal, determine validity of the received interrogation signal, and responsively generate the reply signal in response thereto to a valid interrogation signal.

14: The zone marker of claim 13, further comprising packaging encompassing the antenna, processor and transponder, the packaging being structured for being air dropped using a LC-1 pack where after the antenna, processor and transponder are made operational.

15: The zone marker of claim 13, further comprising an interrogation device that is structured for transmitting the Mode S valid interrogation signal.

16: The zone marker of claim 15 wherein the interrogation device further comprises:
a radio antenna structured for transmitting the Mode S radio frequency interrogation signal and receiving the Mode S radio frequency reply signal;
a transponder structured for generating a Mode S radio frequency interrogation signal and coupled to inject the interrogation signal into the antenna; and
a processor that is coupled to receive the Mode S radio frequency reply signal and is further structured for operating one or more algorithms for computing a bearing and range to a source of the reply signal.

17: A zone marker and acquisition system, comprising:
a zone marker, comprising:
a dedicated L-band radio antenna structured for receiving a valid Mode S radio frequency interrogation signal and broadcasting a Mode S radio frequency reply signal,
a dedicated Mode S transponder structured for generating a Mode S radio frequency reply signal and coupled to inject the reply signal into the antenna, and
a dedicated processor coupled for receiving the Mode S radio frequency interrogation signal from the antenna and structured for operating one or more algorithms for automatically generating a Mode S radio frequency reply signal in response thereto, the processor further coupled for causing the transponder to inject the reply signal into the antenna; and
an interrogation device that is structured for transmitting the valid Mode S interrogation signal, the interrogation device comprising:
a dedicated L-band radio antenna structured for transmitting the valid Mode S radio frequency interrogation signal and receiving the Mode S radio frequency reply signal;
a dedicated transponder structured for generating a Mode S radio frequency interrogation signal and coupled to inject the valid interrogation signal into the antenna; and
a dedicated processor that is coupled to receive the Mode S radio frequency reply signal and is further structured for operating one or more algorithms for computing a bearing and range to a source of the reply signal.

18: The system of claim 17 wherein the reply signal further comprises Mode S type unique address code identification and altitude information.

19: The system of claim 17 wherein the reply signal further comprises latitude, longitude, and altitude data of the zone marker.

20: The system of claim 17 wherein the zone marker processor generates an automatic and periodic broadcast of the Mode S radio frequency reply signal, the reply signal further comprising positional and unique identification data.
